(19) United States
(12) Patent Application Publication
(10) Pub. No.: US 2006/0047806 A1
(43) Pub. Date: Mar. 2, 2006

(54) Mediation-based methods and devices for updating operations support systems

(76) Inventor: Matthias Bannach, Setauket, NY (US)

Correspondence Address: HARNESS, DICKEY & PIERCE, P.L.C., P.O. Box 8910, Reston, VA, 20195, US

(21) Appl. No.: 10/923,867

(22) Filed: Aug. 24, 2004

(51) Int. Cl. H04L 12/28

(52) U.S. Cl. 709/224

(57) ABSTRACT

The cost of updating an operations support system may be reduced by using a mediation unit that is capable of transforming changes made to any number of different, vendor-specific network elements. The transformations involve the generation of a more generalized, normalized set of changes that are recognizable by the operations support system.

### BACKGROUND OF THE INVENTION

Overly simplified, one way to view a data network or set of managed applications (e.g., a web server, firewall, etc.) is to separate the network or application into two types of nodes (e.g., routers, switches, web servers, etc.); those that perform functions necessary to carry data across a managed network or perform processing of data, referred to as “network elements” (NE) and those devices which are responsible for monitoring the operation of, and managing the flow of data through the various NEs, which we will call operations support systems (OSS).

For some time now, those skilled in the art have realized that each time a new feature or function is added to an NE, it is necessary to similarly update an associated OSS responsible for managing the NE.

Though most of the initial costs related to the installation of a data network are associated with the various network elements, most of the subsequent costs in operating and maintaining the network are related to the operation of, and the need to update, the OSS. In fact, anecdotally, it is believed by some that 80% of the cost of updating an NE with a new feature or function is related to updating the associated OSS so it will be able to manage this new feature or function.

Updating such systems can be costly. Because of the high costs associated with updating OSSs, each time a feature or function of an NE is changed network operators are typically faced with two, highly undesirable choices: either pay the high costs and update their OSSs or forego updating their systems. In the former, the costs can severely impact a network's profitability. In the latter, chaos may result if an OSS is not capable of managing a new feature or function of an NE. Said another way, without updating the OSS, the operator of the network or application may have no way of knowing how the NE (or a feature of the NE) is operating, whether it is operating correctly, or even at all. Similarly, the OSS may have no way of knowing how the NE is connected to other NEs, and no way of telling how much data is, or is not, flowing through such an “unmanaged” NE. If an operator repeatedly foregoes updating its OSS, this system may eventually become virtually worthless.

It is therefore desirable to provide for methods and devices which enable an operations support system to be updated when, for example, features and functions of associated network elements change without incurring the high costs associated with existing updating techniques.

### SUMMARY OF THE INVENTION

We have recognized that the problems associated with updating operations support systems may be solved by providing a mediation unit that is operable to transform vendor-specific meta-data (collectively, “meta-meta data”, “meta-data” and “raw data” will be referred to as “meta-data”) and associated definitions, representing changes, etc., from one or more different types of NEs, to one or more forms of normalized meta-data and definitions. Each of the forms of normalized meta-data and definitions may also be processed by the mediation unit and then forwarded to an OSS to allow the OSS to track changes to the network element(s), etc,. Because a single mediation unit is capable of transforming and processing changes made to a number of different network elements the cost and complexity of updating an OSS may be reduced.

### BRIEF DESCRIPTION OF THE DRAWINGS

FIG. 1 is a simplified block diagram of a mediation-based technique for updating an operations support system according to one embodiment of the present invention.

FIG. 2 depicts a simplified block diagram of another mediation-based technique for updating an operations support system according to another embodiment of the present invention.

FIG. 3 depicts a simplified block diagram of yet another mediation-based technique for updating an operations support system according to another embodiment of the present invention.

### DETAILED DESCRIPTION OF THE INVENTION

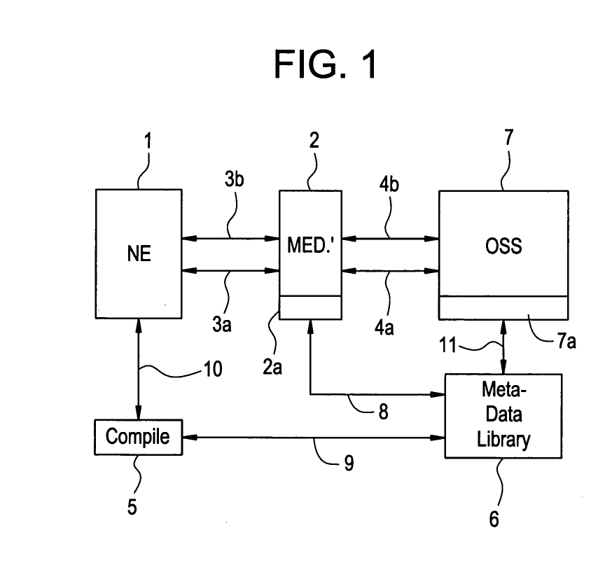

Referring now to FIG. 1, there is shown a simplified block diagram that illustrates components which may be used to update an OSS 7 according to one embodiment of the present invention.

As shown, an NE 1 is shown connected to a mediation unit 2 which in turn is shown connected to the OSS 7. Also shown in FIG. 1 is a meta-data library 6 connected to the NE 1 via a compiler or compilation unit 5. Though only one NE is shown in FIG. 1, it should be understood that NE 1 may comprise one or more network elements.

Generally speaking, the components shown in FIG. 1 operate as follows. Each time a feature or function is added to, or altered within, NE 1, these additions and alterations are made available, or otherwise exposed, or made accessible, to the mediation unit 2. As is known in the art, to add, delete, alter or otherwise change NE 1 requires changes to an information model within an NE referred to as a management information model (MIM) or management information based (MIB) model. So-called meta-data definitions associated with a model used by an NE may be changed as the model is changed. A detailed description of MIB/MIM models or such definitions is beyond the scope of the present invention and is not necessary for an understanding the present invention. Suffice it to say that each manufacturer or vendor of a network element usually creates a vendor-specific, MIB/MIM model and definitions for a specific network element. Complicating matters, even though different NEs may carry out similar functions, each vendor has its own, distinct MIB/MIM models or extensions and definitions. Prior to the inventions disclosed herein, this meant that a network operator that purchased different network elements from different vendors would need an OSS capable of interpreting the MIB/MIM models and definitions of many diverse network elements. This can be costly. Complicating matters even further, the models and definitions for some NEs are sometimes not practically available from the vendor that manufactured the NE. As indicated before, for these reasons, some network operators choose to forego updating their operations support systems altogether while others attempt to do so but at great cost.

These problems are solved by the present invention which provides for the introduction of a mediation unit 2 between the NE 1 and OSS 7 capable of converting or transforming (collectively “transforming”) any one of many different vendor-specific meta-data or definition types into one or more types of meta-data and definitions referred to as “normalized, meta-data or definitions.” In one embodiment of the present invention, the mediation unit 2 operates as follows. At some point in time (e.g., periodically, every second, minute, hour, or upon reception of a notification signal, etc.) the mediation unit 2 may be operable to receive vendor-specific meta-data and definitions from at least one of a plurality of NEs 1 along pathways 3a,3b.

It can be said that the vendor-specific meta-data and definitions received by the mediation unit 2 represent changes to the features and functions of one or more of the NEs 1 or updates to the underlying information model. Before going further, though it has been assumed up to now that the mediation unit 2 automatically (i.e., without human intervention) receives the meta-data and definitions, this may not always be the case. If, for whatever reason, the mediation unit 2 cannot automatically receive the meta-data and definitions, unit 2 is operable to accept manual instructions concerning the additions, alterations, etc. to NE 1's information model as well as data through alternative pathways (not shown in FIG. 1) . It should also be noted that the mediation unit 2 is also capable of receiving data and definitions related to features and functions which remain unchanged. Upon receiving the vendor-specific meta-data and/or definitions, the mediation unit 2 is operable to transform them to normalized meta-data and definitions. This transformation effectively transforms the vendor-specific meta-data and definitions to more generalized or common representations, which we will refer to as normalized meta-data and definitions. This normalized meta-data and/or definitions is then recognizable by the OSS 7. In this manner, changes to the model associated with NE 1 may be tracked by, or used to update, OSS 7.

The mediation unit 2 may comprise a transformation section 2a for carrying out the transformations discussed above and below. Again, though one embodiment of the present invention provides for the automatic transformation of vendor-specific meta-data and definitions to their normalized versions, this transformation may occur manually as well. That is, the instructions necessary to carry out the transformation may be manually input into the mediation unit 2 if such instructions are not already stored within the mediation unit 2 or meta-data library 6. It can be said, then, that the mediation unit 2 is operable to use a transformation model to transform vendor-specific meta-data and definitions into normalized versions.

The mediation unit 2 is capable of so-transforming meta-data and definitions from a plurality of different NEs 1 (i.e., offered by different vendors or different models/versions offered by the same vendor) to normalized versions even though each of the network elements may use different vendor-specific, operation models. Said another way, mediation unit 2 is capable of transforming vendor-specific meta-data and definitions from any number of different vendors' network elements into one or more forms of normalized versions which can be manipulated and analyzed by the OSS 7. In this manner, changes to any one of a number of models associated with NE 1 may be transformed by a single mediation unit 2 and tracked by, or used to update, any one of a number of types of OSS 7.

It may be that a given operator may have different types of OSSs (e.g., Performance OSS, Provisioning OSS, Assurance OSS, Fault OSS, Accounting OSS, Security OSS, etc. to name just a few). In this case, the mediation unit 2 may be operable to transform vendor-specific meta-data and definitions into any one of a number of normalized forms of meta-data and definitions, each form associated with one or more types of OSSs. The ability to so transform varied, vendor-specific meta-data and definitions greatly reduces the costs associated with updating an OSS each time a different NE changes its features or functions. This cost reduction is due, in part, to the fact that there is no need to install additional software or hardware in the mediation unit 2 or OSS 7 to account for a different NE and its associated meta-data and definitions, etc. Instead, all that is required is the initial installation of a mediation unit 2 capable of transforming meta-data and definitions from a plurality of vendor-specific models into one or more normalized models.

Notwithstanding this advantage of the present invention, alternatively, if an existing mediation unit 2 is not capable of transforming certain vendor-specific meta-data and definitions, then transformation sections 2a may be installed, programmed into or plugged into the mediation unit 2 to carry out such transformations. Some of those skilled in the art may refer to these types of installable transformation sections as adapters or plug-ins. In an alternative embodiment of the present invention, each adapter is operable to transform one or more types of vendor-specific meta-data and definitions into normalized versions.

In certain circumstances, an OSS may not be capable of making use of the transformed, normalized meta-data and definitions. In yet another embodiment of the present invention, when this occurs, smaller and less costly software/hardware updates or plug-ins 7a may be added to the OSS 7.

Transformations may be carried out by mediation unit 2 even if no changes are made to NE 1. That is, raw data input into NE 1 is still transformed into normalized raw data and, for example, forwarded on to OSS 7 even though the operation of, or model used by, NE 1 remains the same. This allows the OSS 7 to receive the raw data from NE 1. Those of ordinary skill in the art may realize that this may occur more frequently than transformations related to changes in NE 1.

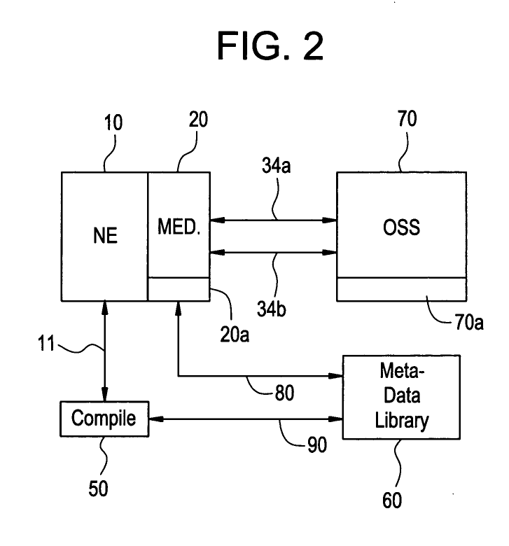

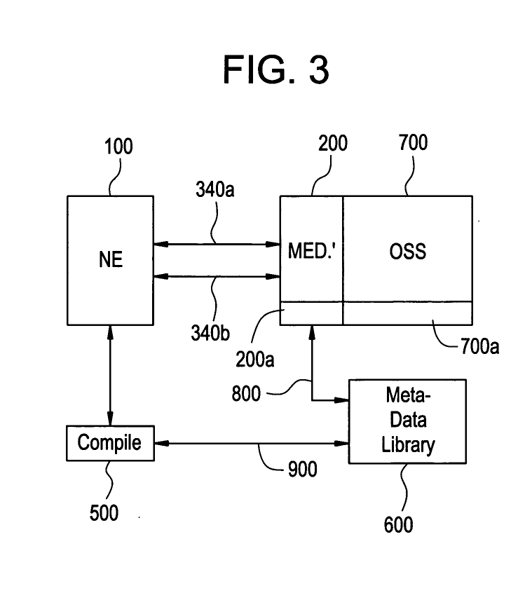

Though shown as individual sections or pathways, it should be understood that the components and pathways shown in FIG. 1 (as well as FIGS. 2 and 3) may be combined into fewer components/pathways or further broken down into additional components/pathways. It should be further understood that many of the components and sections shown in FIG. 1 are typically embodied in one or more software programs but may also be embodied in a combination of hardware (e.g., one or more programmed mediums, such as a processor) software and firmware depending on the specific design chosen. The NE 1 may comprise any number of devices or programs, such as a router, web server, communications switch, firewall, proxy, gateway, etc. It should be further understood that the various sections and units shown in FIG. 1 (as well as the other figures) may use wired or wireless pathways to transfer the various forms of data and definitions using any one of a number of modulation schemes and communication protocols.

In addition to transforming meta-data and definitions, mediation unit 2 may also be operable to process either the original versions or normalized versions of meta-data and definitions in order to interpret the meta-data or definitions (e.g., traffic flow patterns) or to analyze the present structure or operation of NE 1 or the network it is contained within/connected to, etc, (collectively, referred to as “processing”). The results of this processing are then shared (i.e., forwarded) to OSS 7 so that the operation of NE 1 and the network may be monitored or maximized (may collectively be referred to as monitoring the network element or a network associated with the element).

By carrying out the transformations and processing discussed above, mediation unit 2 may be said to shield the OSS 7 from the effects (and therefore the costs) associated with changes to NE 1. Mediation unit 2, in conjunction with library 6, may bear the costs, but these costs are substantially less than that which would otherwise be required.

We turn briefly now to a discussion of the other elements of FIG. 1. Generally, for transforming meta-data, the mediation unit 2 may be operable to receive one or more transformation models, each of which includes at least transformation meta-data and definitions, from the meta-data library 6. A detailed discussion of the operation of the meta-data library 6 is beyond the scope of the present invention. A more detailed discussion can be found in co-pending U.S. patent application Ser. No.______, which is incorporated by reference as if set forth in full herein. In brief, the meta-data library 6 is operable to store at least: (a) one or more transformation models and associated meta-data and definitions used to transform one or more vendor-specific models to one or more normalized models; (b) one or more of the vendor-specific models and associated meta-data and definitions; and (c) one or more forms of a normalized model and associated meta-data and definitions used by OSS 7. Though the meta-data and definitions may be stored elsewhere, e.g., within the mediation unit 2, they are advantageously stored within library 6.

In yet another embodiment of the present invention, the library 6 may be operable to forward all of the models (i.e., the appropriate vendor-specific meta-data/definitions, appropriate transformation meta-data/definitions, normalized meta-data/definitions to mediation unit 2 so that mediation unit 2 can carry out an appropriate transformation. The library 6 is also operable to analyze vendor-specific meta-data and definitions received from mediation unit 2 or manually (e.g., from a network operator) to identify any changes to the features, functions, model, meta-data, etc. of an NE 1. The meta-data library 6 may make use of sophisticated modeling techniques to carry out analysis of any of the above indicated information. Again a more detailed discussion of library 6 can be found in co-pending U.S. patent application Ser. No. ______, mentioned above.

The library 6 may also be used to update NE 1. For example, instead of changing the features, functions, etc. of NE 1 and then having the mediation unit 2, for example, retrieve those changes and go through a transformation/normalization process, a design engineer or the like may choose to use library 6 to make changes to the model used by NE 1. The details of this process are set forth in co-pending U.S. patent application Ser. No. ______, referred to above. Suffice it to say that, by utilizing library 6 to make changes to NE 1, the transformation/normalization process may be greatly simplified resulting in a further cost reduction/savings. In effect, this is akin to placing a mediation unit into an NE. FIG. 2 depicts just such an embodiment of the present invention where a mediation unit 20 and a conversion section 20a are made a part of an NE 10. In this embodiment, it is assumed that each vendor will incorporate, or allow the incorporation of, a mediation unit 20 into its NE 10. Whether this will happen is problematic; that is, each vendor will probably make its own determination whether or not it will incorporate a mediation unit into one of its routers or the like.

If changes to an NE are made without using a library directly, those changes are sent to the library by a mediation unit or compiler. Upon reception of these changes, the library is operable to revise the model of the NE it has stored and to generate a new transformation model for the NE. Both the new model (vendor-specific) and new transformation model can then be sent to the mediation unit to allow the mediation unit to complete a transformation/normalization process. In this manner, the library and mediation unit work in conjunction with one another to ensure that each change to an NE is sent to an OSS in the form of transformed, normalized meta-data and data.

Alternatively, a mediation unit 200 may be incorporated into an OSS 700, as shown in FIG. 3, in which case the new transformation and vendor-specific models may be sent by the library 600 to the OSS 700.

The last component shown in FIGS. 1-3 is the OSS 7, 70, 700, respectively. A detailed description of the operations support system 7, 70, 700 is beyond the scope of the present invention. Co-pending U.S. patent application Ser. No. ______, which is incorporated by reference as if set forth in full herein, provides a more detailed discussion of systems 7, 70, 700. That said, in brief, as indicated above, each OSS is operable to receive the transformed, normalized meta-data and definitions in an appropriate form. Thereafter, each OSS is operable to alter the management instructions and data it has stored.

The above discussion has attempted to set forth some examples of the present invention. Other examples may be envisioned without departing from the spirit and scope of the present invention which is better defined by the claims which follow wherein the word “or” means a mediation unit or method which involves: (i) meta-data or definitions; (ii) meta-data and definitions; or (iii). both (i) and (ii).

We claim:

1. A mediation unit operable to:
receive vendor-specific meta-data from at least one of a plurality of network elements; and
transform the received meta-data into one or more forms of normalized meta-data.

2. The mediation unit as in claim 1 further operable to process the received meta-data in order to monitor the network element or a network associated with the element.

3. The mediation unit as in claim 1 further operable to receive a transformation model to transform the vendor-specific meta-data into the normalized meta-data.

4. The mediation unit as in claim 1 further operable to manually receive a transformation model to transform the vendor-specific meta-data into the normalized meta-data.

5. The mediation unit as in claim 1 wherein each form of normalized meta-data is associated with one or more operations support systems.

6. The mediation unit as in claim 1 wherein the mediation unit is further operable to forward one or more forms of normalized meta-data or raw data on to one or more operations support systems.

7. The mediation unit as in claim 1 further operable to manually receive the vendor-specific meta-data.

8. The mediation unit as in claim 1 further operable to transform one or more vendor-specific models from one or more network elements into one or more normalized models.

9. The mediation unit as in claim 1 wherein the mediation unit is part of a network element.

10. The mediation unit as in claim 1 wherein the mediation unit is part of an operations support system.

11. The mediation unit as in claim 10 further operable to receive the one or more vendor-specific models from a network element.

12. A method for transforming meta-data from one or more network elements into one or more forms for use by one or more operations support systems comprising:
receiving vendor-specific meta-data from at least one of a plurality of network elements; and
transforming the received meta-data into one or more forms of normalized meta-data.

13. The method as in claim 12 further comprising processing the received meta-data in order to monitor the network element or a network associated with the element.

14. The method as in claim 12 further comprising receiving a transformation model to transform the vendor-specific meta-data into the normalized meta-data.

15. The method as in claim 12 further comprising manually receiving a transformation model to transform the vendor-specific meta-data into the normalized meta-data.

16. The method as in claim 12 wherein each form of normalized meta-data is associated with one or more operations support systems.

17. The method as in claim 12 further comprising forwarding one or more forms of normalized meta-data on to one or more operations support systems.

18. The method as in claim 12 further comprising manually receiving vendor-specific meta-data.

19. The method as in claim 12 further comprising transforming one or more vendor-specific models from one or more network elements into one or more normalized models.

20. The method as in claim 19 further comprising receiving the one or more vendor-specific models from a network element.
